(19) United States
(12) Patent Application Publication
(10) Pub. No.: US 2008/0290650 A1
(43) Pub. Date: Nov. 27, 2008

(54) Pad for Vessels with Liquid

(76) Inventor: Sergey Valentinovich Valkov, Konakovo (RU)

Correspondence Address: Aleksandr Smushkovich, P.O.Box 140505, Brooklyn, NY, 11214, US

(21) Appl. No.: 11/629,597

(22) PCT Filed: Feb. 10, 2006
(86) PCT No.: PCT/RU2006/000074

§ 371 Date: Dec. 14, 2006

(30) Foreign Application Priority Data
Dec. 27, 2005 (RU) 2005141795

(51) Int. Cl. B42D 15/00; A47G 29/00

(52) U.S. Cl. 283/105; 248/346.11

(57) ABSTRACT

The inventive support for liquid-containing vessels can be used for kitchen ware, for example for beer mugs. The structural design of said support makes it possible to reduce the support separation forces and to increase the absorbing capacity thereof by means of an additional internal layer. Said support for liquid-containing vessels consists of at least two layers, which are connected to each other and provided with an information carrier arranged therebetween or a piece of information is located on one layer, and is embodied in such a way that it is breakable or disreputable. A break or disrupt line can be provided with notches or perforations or the support can have a thickening area. The layer and/or information carrier can be made from a sheet material.

### TECHNICAL FIELD

The present invention discloses a pad, intended for kitchen hardware, placeable under vessels with liquid; preferably such pad is placeable under a mug or glass with beer.

### BACKGROUND OF THE INVENTION

There are known pads particularly intended for placement under glasses or mugs with beer, in German called beerdekels.

In February 2002, Internet-Magazine “Pivnoye Delo” published an article about beerdekels (http://www.pivnoe-delo.com/?mag=19&op=journal&txt=7). According to the article, a beerdekel, or a cover for a mug with beer, appeared in 1880. First beerdekels were used as an upper cover for the mug, later they were utilized as a pad capable to absorb beer often spilled over from the mug, thereby saving labor of servants in pubs, beer bars, or cafés, and providing better sanitation conditions.

A variation of inexpensive moisture-absorbing beerdekels was patented as “a pad of formed fiber” by a German inventor Schput in 1893, which pad had a diameter of 107 mm and a thickness of 5 mm. First European quality beerdekels were introduced to the market of Russia in the middle of 1990-s by companies Marienthaler and KATZ International Coasters, affiliated with European manufacturers. The largest consumer companies in Russia today are Sun-Interbrew and BBH.

Typical materials for production of beerdekels are special hygroscopic cardboards. The standard amount of water absorption is 1 ml of liquid during 30 seconds. Non-hygroscopic materials are not used in manufacturing of the pads. The thickness of such pads typically fits in the range from 0.9 mm to 2.5 mm.

Besides their absorbing qualities, other popular features of today's beerdekels are the use as an advertising medium and as a gaming means (such as a roulette whipping-top, for playing “tick-tack-toe”, mini-checkers, “frisbee”, etc.). Sometimes they are used for sprint-drawings of lottery prizes, which is a powerful tool for sales promotion.

### BRIEF SUMMARY OF THE INVENTION

Therefore, one of aims of the present invention is producing a useful and novel pad capable to be utilized for placement under vessels with liquid, preferably beer mugs and glasses.

Another aim of the present invention is the development of a pad utilized in a drawing of a prize as a lottery ticket. An information carrier contains a sign or symbols of the prize (prize information) and is disposed inside the pad. A participant of the prize drawing breaks (tears) the pad, and, getting access to the information carrier, determines the prize.

Another aim of the present invention is a reduction of effort for taking apart the pad by providing a rift line or a thinned zone on the pad.

Another aim of the present invention is increasing the capacity to absorb the liquid by providing an additional inner layer of moisture-absorbing material.

Other aims of the invention will become apparent from a consideration of the drawings, ensuing description, and claims as hereinafter related.

The present invention proposes a pad placeable under vessels with liquid (preferably beer), characterized in that it comprises at least two layers, joined with each other, between which layers an information carrier is disposed, or alternatively the prize information is placed on one of the layers, and the pad is performed with a possibility of breaking or tearing (the prize information is hidden inside the pad; in order to get access to the information the pad need be destroyed).

The pad is characterized in that it comprises a rift line of breaking or tearing that is furnished with notches or perforations, or the pad has a thinned zone.

The pad is characterized in that a layer and/or the information carrier are preferably made of a sheet-shaped material.

Therefore, the pad should combine at least the following features: be composed of a material with a predetermined hydroscopic characteristic; be assembled from at least two layers; prize information is to be placed between any two of the layers, or on one of the layers; the layers comprise a rift line or a thinned zone for easy braking or tearing.

### BRIEF DESCRIPTION OF DRAWINGS

FIG. 1—a perspective view of the inventive pad in an assembled position, according to an embodiment of the present invention;

FIG. 2—a perspective view of the inventive pad showing a breaking of the pad by deformation (bending down), according to an embodiment of the present invention;

FIG. 3—a perspective view of the inventive pad showing a breaking of the pad by deformation (bending up), according to an embodiment of the present invention;

FIG. 4—a perspective view of the inventive pad showing a pulling the pad's portions towards opposite sides, according to an embodiment of the present invention;

FIG. 5—a perspective view of the inventive pad showing an extraction of the information carrier detached from both the sides, according to an embodiment of the present invention;

FIG. 6—a perspective view of the inventive pad layers, showing the information carrier between the pad layers and depicting a rift line, according to an embodiment of the present invention;

FIG. 7—a perspective view of the inventive pad showing an information carrier fixed to one of the pad's layers,

FIG. 8—a perspective view of the inventive pad showing how information is placed immediately on one of the layers and depicting a rift line, according to an embodiment of the present invention;

FIG. 9—a perspective view of the inventive pad showing a pad's embodiment in a rectangular shape and depicting a rift line, according to an embodiment of the present invention;

FIG. 10—a perspective view of the inventive pad showing a pad's embodiment in a rectangular shape with rounded corners and depicting a rift line, according to an embodiment of the present invention;

FIG. 11—a perspective view of the inventive pad showing a pad's embodiment in a round shape and depicting two rift lines, according to an embodiment of the present invention;

FIG. 12—a perspective view of the inventive pad showing a pad's embodiment in a rounded shape and depicting a thinned rift zone, according to an embodiment of the present invention.

The above figures enumerate the following reference numerals: 1,2—upper and lower layers, 3—rift line, 4—information carrier, 5—thinned zone.

### A PREFERRED EMBODIMENT OF THE PRESENT INVENTION

While the invention may be susceptible to embodiment in different forms, there are shown in the drawings, and will be described in detail herein, specific embodiments of the present invention, with the understanding that the present disclosure is to be considered an exemplification of the principles of the invention, and is not intended to limit the invention to that as illustrated and described herein.

According to the aims set forth above, the inventive pad provides for its use for prize drawings, wherein the prize information is hidden inside the pad; in order to get access to the information the pad need be destroyed.

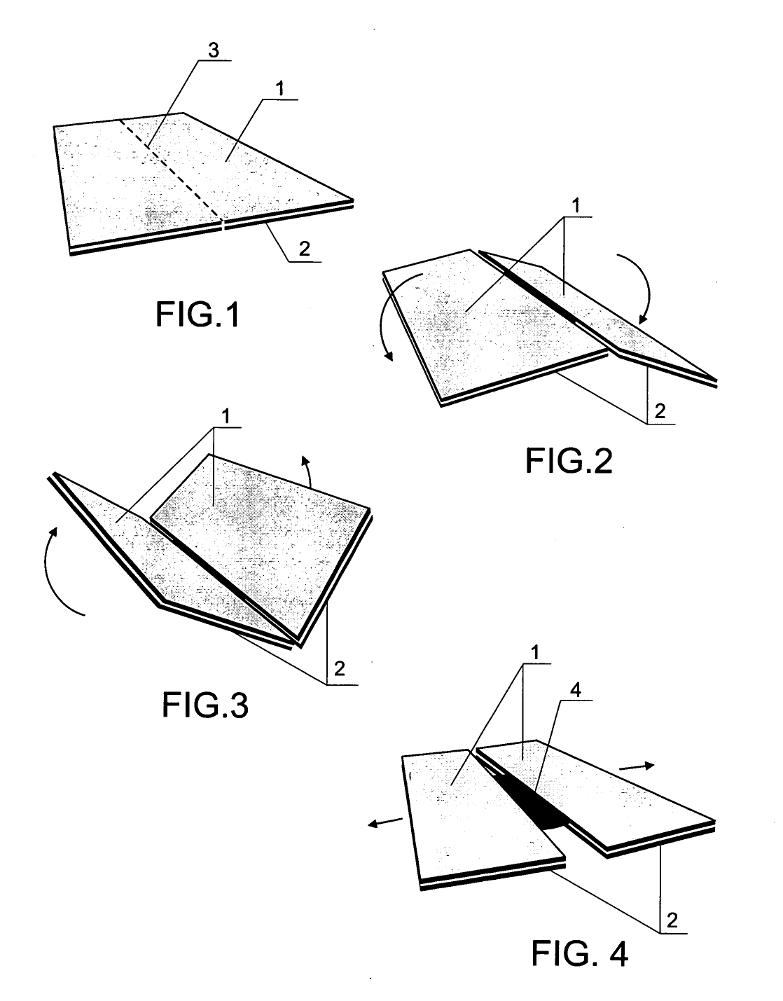

Different embodiments of the pads are illustrated on FIG. 1,2,3,4,5,6,7,8,9,10,11,12.

The pad typically comprises two layers 1,2, coupled to each other, for instance, by glue. The coupling should be so firm that after an attempt of detachment of the parts they could not be repeatedly coupled with attaining the initial solidity of the pad. Exemplarily, a cardboard “beermat” intended for manufacturing pads-beerdekels can be used as a material for production of the pad.

After assembling (coupling), an area is formed in the central region of the article, in which area the layers 1, 2 closely fit to each other, but not attached. A prize information carrier 4 is placed into the area prior to assembling. A sheet-shaped material (paper, cardboard, plastic, metal, fabric, etc.) can be utilized for an information carrier, which constitutes an additional inner (third) layer. The information carrier is accessible only by taking the pad apart, that is breaking it. The information carrier of the additional inner layer may have any desirable shape.

In a preferred embodiment, the information carrier is a stiff paper or thin polymer (e.g. the synthetic paper “polylit”). The information carrier is positioned at the center of the pad, or to the right (left) from the center. Prior to the assembling, notches or perforations are performed in the bodies of the layers, forming a rift line 3. In some cases, due to material peculiarities or other reasons, the notches cannot be made, then a thinning is possible, e.g. by a method of an orderly scratching the material of at least one layer of the pad in a thinned zone 5.

The rift lines of the layers are brought together during the assembling. The notches are typically performed so that the rift line extends through the central area of the pad with the information carrier (FIG. 1, 6, 8).

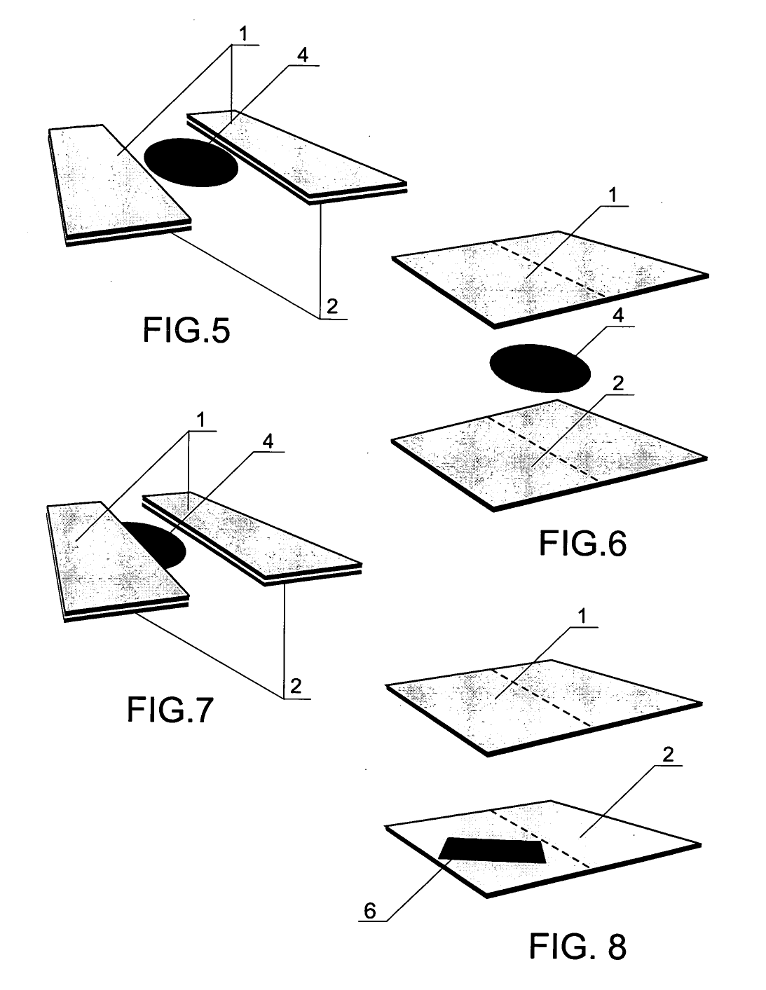

A deformation of the pad along the rift line results in dividing the pad into two parts (e.g. halves), though if there are several rift lines, the number of the parts can be greater—see FIG. 2-5, FIG. 11. The dividing into the parts provides access to the information carrier, or to the prize information itself placed on one of the layers (FIG. 5,7,8). In an embodiment, the information carrier can be fixed to one of the parts of the dividable pad (FIG. 7).

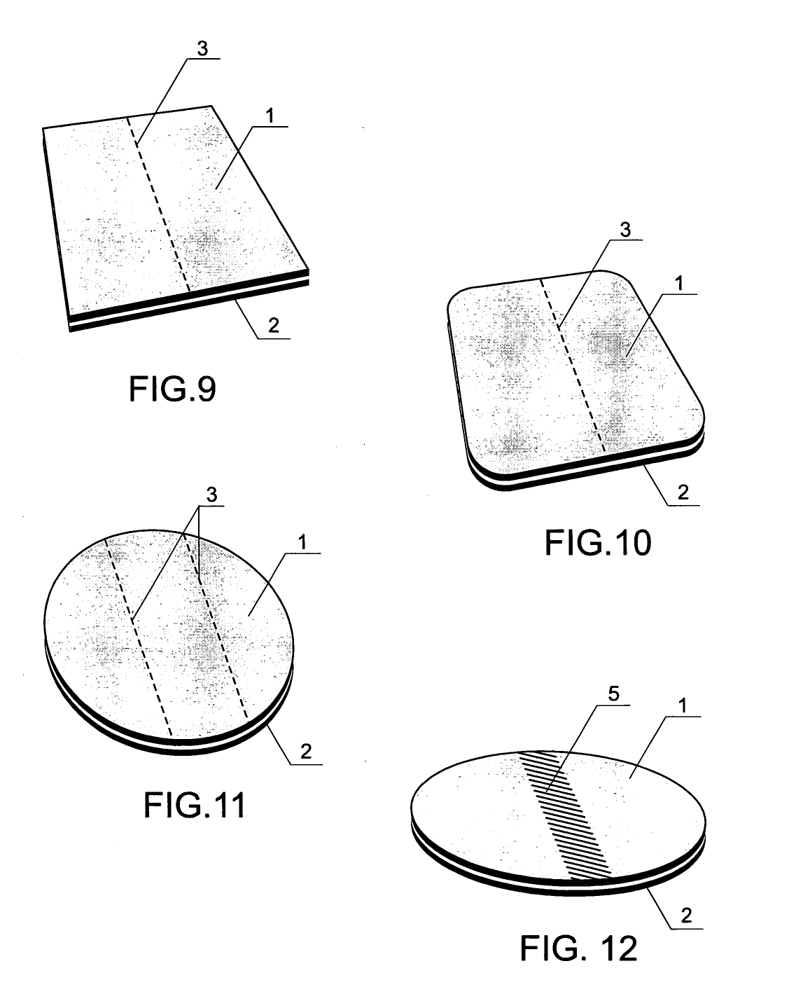

The pad and the information carrier can be shaped as desired. The basic shapes are a round, a square, a square with rounded corners, and an oval (see FIG. 9-12).

Comparatively to known prior art liquid pads, the inventive pad is particularly advantageous due to the enclosing of prize information or the information carrier inside the pad, and a substantial reduction of effort for taking apart the pad. The pad is easy to produce, and convenient to use.

1. A pad for vessels with liquid usable for participation in a prize drawing game, comprising at least two layers joined to each other; a prize information carrier disposed between the layers, or prize information placed on one of the layers; and the pad is performed with a possibility for breaking or tearing for creating access to said prize information or prize information carrier.

2-3. (canceled)

4. The pad according to claim 1, composed of liquid absorbing materials with predetermined hydroscopic properties.

5. The pad according to claim 4, further comprising either a rift line furnished with notches or perforations, or a thinned zone, to facilitate said breaking or tearing.

6. The pad according to claim 4, wherein at least one of the layers and the prize information carrier made of sheet-shaped material.
